(19) United States
(12) Patent Application Publication
(10) Pub. No.: US 2006/0276191 A1
(43) Pub. Date: Dec. 7, 2006

(54) System and method for performing handover in a mobile communication system

(75) Inventors: Sung-Soo Hwang, Seoul (KR); Soong-Yoon Choi, Suwon-si (KR); Sei-Jei Cho, Seoul (KR); Soon-Young Yoon, Seoul (KR); Ki-Young Han, Yongin-si (KR); Yong-Seok Kim, Suwon-si (KR); Eun-Sun Choi, Gwacheon-si (KR); Young-Hoon Kwon, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/433,268

(22) Filed: May 12, 2006

(30) Foreign Application Priority Data
May 12, 2005 (KR) 39783/2005

(51) Int. Cl. H04Q 7/20

(52) U.S. Cl. 455/436; 370/331

(57) ABSTRACT

Provided is a method for determining handover of a mobile station by a serving base station in a mobile communication system. The method includes receiving traffic quality information from the mobile station; determining whether the traffic quality information satisfies a preset setting condition; if the traffic quality information satisfies the setting condition, sending a request for pilot signal strength measurement for the serving base station and adjacent base stations to the mobile station; receiving pilot signal strengths of the base stations, reported by the mobile station; determining whether there is a corresponding base station whose pilot signal strength exceeds the pilot signal strength of the serving base station; and determining handover of the mobile station to the corresponding base station.

### PRIORITY

This application claims the benefit under 35 U.S.C. § 119(a) of an application entitled “System and Method for Performing Handover in a Mobile Communication System” filed in the Korean Intellectual Property Office on May 12, 2005 and assigned Serial No. 2005-39783, the contents of which are hereby incorporated by reference.

### BACKGROUND OF THE INVENTION

1. Field of the Invention

The present invention relates generally to a mobile communication system, and in particular, to a system and method for performing handover by a mobile station.

2. Description of the Related Art

Generally, in a cellular mobile communication system, a base station (BS) manages one cell and provides services to mobile stations (MSs) located in the cell. The cell may be divided into a plurality of sectors. The mobile station can move from the cell or sector where it currently receives a service to an adjacent cell or sector. In this case, the mobile station performs handover of a call to a base station of another base station, i.e., a target base station, in a base station of its current cell, i.e., a service base station. The handover is a very important factor that should be taken into account in connection with traffic quality maintenance and service provision for the mobile station.

With reference to the diagram of FIG. 1, a description will now be made of a configuration of a mobile communication system in association with handover of the conventional mobile station.

FIG. 1 is a diagram schematically illustrating a configuration of a mobile communication system in association with handover of the conventional mobile station.

Referring to FIG. 1, the mobile communication system has a cell configuration including at least one cell. That is, the mobile communication system has a cell 100 and a cell 150, and there are a base station 110 for controlling the cell 100 and a base station 140 for controlling the cell 150. The base stations 110 and 140 provide services to a plurality of mobile stations 111, 113, 130, 151 and 153. Signal exchange between the base stations and the mobile stations can be achieved using Code Division Multiple Access (CDMA), Orthogonal Frequency Division Multiplexing (OFDM), or Orthogonal Frequency Division Multiple Access (OFDMA).

Of the mobile stations 111, 113, 130, 151 and 153, the mobile station 130 is located in a boundary region, i.e., a handover region, between the cell 100 and the cell 150. Therefore, the mobile station 130, if it satisfies a preset handover condition, can perform handover to any one cell.

With reference to the flow chart of FIG. 2, a description will now be made of a handover process performed by the conventional mobile station.

FIG. 2 is a flowchart illustrating a handover process performed by a mobile station in the conventional mobile communication system.

Referring to FIG. 2, in step 202, the mobile station receives pilot signals from a serving base station and adjacent base stations. In step 204, the mobile station measures strengths of pilot signals received from the serving base station and the adjacent base stations. In step 206, the mobile station determines whether there is any pilot signal strength greater than or equal to a preset threshold among the measured pilot signal strengths for the serving base station and the adjacent base stations. If there is any pilot signal strength greater than or equal to the threshold, the mobile station proceeds to step 208. However, if there are only the pilot signal strengths lower than the threshold, the mobile station performs again step 202 and its succeeding steps.

In step 208, the mobile station transmits a message including the measured pilot signal strengths and a pseudo noise offset for identification of a corresponding base station to the serving base station. Upon receiving the message, the serving base station determines a target base station satisfying a preset handover condition, and sends a handover request to the mobile station.

As described above, in the conventional handover process, the mobile station measures pilot signal strengths received from the adjacent base stations, and transmits to the serving base station a message including information on the adjacent base station(s) with pilot signal strength greater than or equal to a preset threshold, and the pilot signal strength of the adjacent base station. The serving base station determines a target base station to which the mobile station will perform handover, depending on the message received from the mobile station, and sends the determined information to the mobile station, thereby requesting handover of the mobile station. The mobile station performs handover to the target base station in response to the handover request from the serving base station.

Conventionally, therefore, in order to determine handover, the mobile station periodically receives pilot signals from the serving base station and the adjacent base stations, and measure pilot signal strengths of the received signals. As a result, calculations required by the mobile station in continuously measuring the pilot signal strengths serves as a load on the mobile station. Therefore, the mobile station may unnecessarily measure the pilot signal strengths even though there is a low possibility of performing handover, causing overhead.

### SUMMARY OF THE INVENTION

It is, therefore, an object of the present invention to provide a handover system and method for reducing a calculation load of a mobile station in a mobile communication system.

It is another object of the present invention to provide a system and method in which a base station sends a request for pilot signal strength measurement to a mobile station according to traffic quality information in a mobile communication system, thereby reducing overhead caused by frequent handover.

According to one aspect of the present invention, there is provided a method for determining handover of a mobile station by a serving base station in a mobile communication system. The method includes receiving traffic quality information from the mobile station; determining whether the traffic quality information satisfies a preset setting condition; if the traffic quality information satisfies the setting condition, sending a request for pilot signal strength measurement for the serving base station and adjacent base stations to the mobile station; receiving pilot signal strengths of the base stations, reported by the mobile station; determining whether there is a corresponding base station whose pilot signal strength exceeds the pilot signal strength of the serving base station; and determining handover of the mobile station to the corresponding base station.

According to another aspect of the present invention, there is provided a method for performing handover by a mobile station in a mobile communication system. The method includes transmitting traffic quality information to a serving base station of the mobile station; upon receiving a pilot signal strength measurement request from the serving base station, measuring pilot signal strengths of the serving base station and adjacent base stations, and reporting the measured pilot signal strengths to the serving base station; and upon receiving a handover request from the serving base station, performing handover to a corresponding base station determined by the serving base station.

According to further another aspect of the present invention, there is provided a method for performing handover between a mobile station and a serving base station in a mobile communication system. The method includes transmitting, by the mobile station, traffic quality information to the serving base station; receiving, by the serving base station, the traffic quality information from the mobile station; determining by the serving base station whether the traffic quality information satisfies a preset setting condition; if the setting condition is satisfied, sending a request for pilot signal strength measurement for the serving base station and adjacent base stations, to the mobile station; measuring, by the mobile station, pilot signal strengths of the serving base station and adjacent base stations in response to the pilot signal strength measurement request from the serving base station, and reporting the measured pilot signal strengths to the serving base station; receiving, by the serving base station, the measured pilot signal strengths of the base stations, reported by the mobile station; determining by the serving base station whether there is a corresponding base station whose pilot signal strength exceeds the pilot signal strength of the serving base station; if there is a corresponding base station, sending, by the serving base station, a request for handover to the corresponding base station to the mobile station; and determining, by the mobile station, handover to the corresponding base station.

According to yet another aspect of the present invention, there is provided a system for performing handover in a mobile communication system. The system includes a mobile station and a serving base station. The mobile station transmits traffic quality information to the serving base station, and upon receiving a pilot signal strength measurement request from the serving base station, measures pilot signal strengths of the serving base station and adjacent base stations and reports the measured pilot signal strengths to the serving base station, and upon receiving a handover request to a particular base station from the serving base station, performs handover to the particular base station. The serving base station receives traffic quality information from the mobile station, determines whether the traffic quality information satisfies a preset setting condition, if the setting condition is satisfied, sends a request for pilot signal strength measurement for the serving base station and adjacent base stations to the mobile station, receives pilot signal strengths of the base stations, reported by the mobile station; determines whether there is a particular base station whose pilot signal strength exceeds the pilot signal strength of the serving base station, and if there is the particular base station, sends a request for handover to the particular base station to the mobile station.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a configuration of a mobile communication system in association with handover of the conventional mobile station;

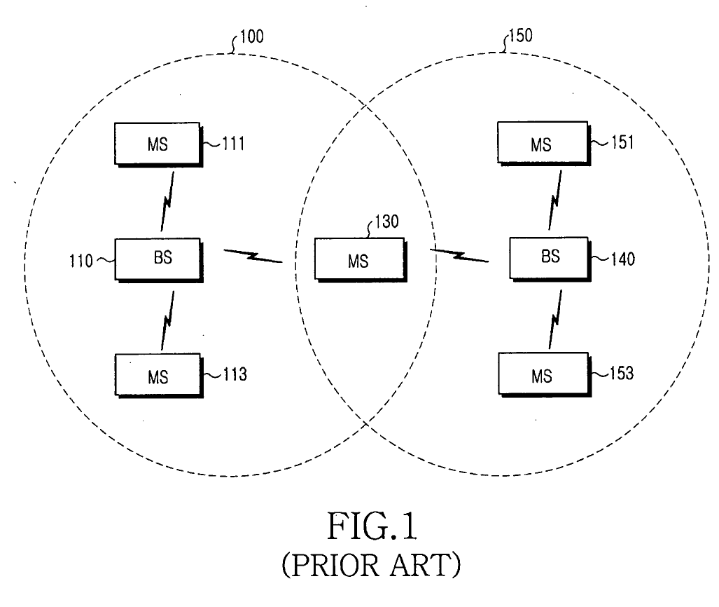

FIG. 2 is a flowchart illustrating a handover process performed by a mobile station in the conventional mobile communication system;

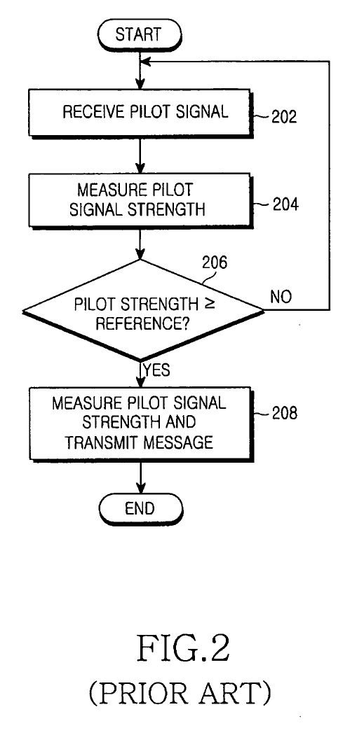

FIG. 3 is a flowchart illustrating a process of performing handover by a mobile station according to a first embodiment of the present invention;

FIG. 4 is a flowchart illustrating a process of performing handover by a mobile station according to a second embodiment of the present invention;

FIG. 5 is a flowchart illustrating a process of determining handover of a mobile station by a serving base station according to a first embodiment of the present invention; and

FIG. 6 is a flowchart illustrating a process of determining handover of a mobile station by a serving base station according to a second embodiment of the present invention.

### DETAILED DESCRIPTION OF PREFERRED EMBODIMENTS

Several embodiments of the present invention will now be described in detail with reference to the annexed drawings. In the following description, a detailed description of known functions and configurations incorporated herein has been omitted for clarity and conciseness.

In the present invention, a mobile station transmits traffic quality information to a serving base station on an uplink and a downlink. The serving base station can reduce a calculation load of the mobile station by determining and sending a pilot signal strength measurement request to the mobile station taking the traffic quality information into account.

Herein, in the downlink, the traffic quality information can be Channel Quality Information (CQI) obtained by the mobile station by periodically measuring pilot signals from the serving base station, and in the uplink, the traffic quality information can be headroom information indicating a difference between the maximum power transmittable by the mobile station and the current transmission power, or a Modulation and Coding Scheme (MCS) level selected by the mobile station in an MCS level recommended by the serving base station.

The MCS level means sets of modulation schemes and coding schemes, and can be defined as MCS level #1 through MCS level #N according to the number of the MCSs. That is, the MCS level is adaptively determined according to a channel state between the mobile station and the base station. For a good channel state between the mobile station and the base station, a high MCS level of 64-ary Quadrature Amplitude Modulation (64QAM) and 5/6 code rate can be used, and for a bad channel state, a low MCS level of Quadrature Phase Shift Keying (QPSK) and 1/12 code rate can be used.

The mobile station may use the MCS level determined by the serving base station, or select one of MCS levels recommended by the serving base station. In the former case where the MCS level is determined by the serving base station, the mobile station has no need to transmit the MCS level to the base station as the traffic quality information. In the latter case where the mobile station selects one of the MCS levels recommended by the serving base station, the mobile station sends the selected MCS level information to the serving base station.

In a first embodiment of the present invention, the mobile station transmits traffic quality information including CQI and headroom information to the serving base station, and the serving base station can send a request for pilot signal strength measurement to the mobile station taking the CQI and headroom information into account.

In a second embodiment of the present invention, the mobile station transmits traffic quality information including CQI, headroom information, and an MCS level to the serving base station, and the serving base station can send a request for pilot signal strength measurement to the mobile station taking into account the CQI, headroom information, and MCS level information.

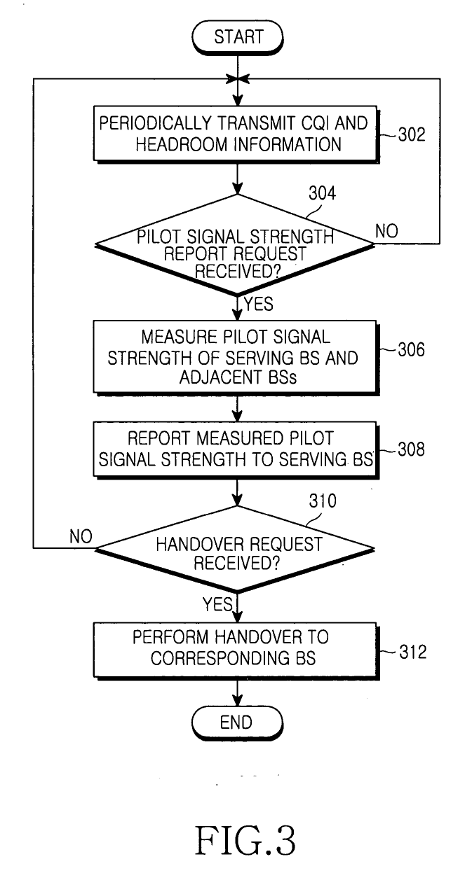

FIG. 3 is a flowchart illustrating a process of performing handover by a mobile station according to a first embodiment of the present invention.

Referring to FIG. 3, in step 302, the mobile station periodically transmits CQI and headroom information to a serving base station. In step 304, the mobile station determines whether there is a request for pilot signal strength measurement for the serving base station and adjacent base stations, received from the serving base station. Upon receipt of the pilot signal strength measurement request, the mobile station proceeds to step 306. However, upon failure to receive the pilot signal strength measurement request, the mobile station repeats step 302 and its succeeding steps.

In step 306, the mobile station, as it receives the pilot signal strength measurement request from the serving base station, measures pilot signal strengths of the serving base station and the adjacent base stations. In step 308, the mobile station reports the measured pilot signal strengths of the base stations to the serving base station. Herein, the pilot signal strength can be a Carrier to Interference and Noise Ratio (CINR). The mobile station determines in step 310 whether there is a request for handover to another base station different from the serving base station, received from the serving base station. Upon receipt of the handover request, the mobile station proceeds to step 312 where it performs handover to the corresponding base station determined by the serving base station. However, upon failure to receive the handover request, the mobile station repeats step 302 and its succeeding steps.

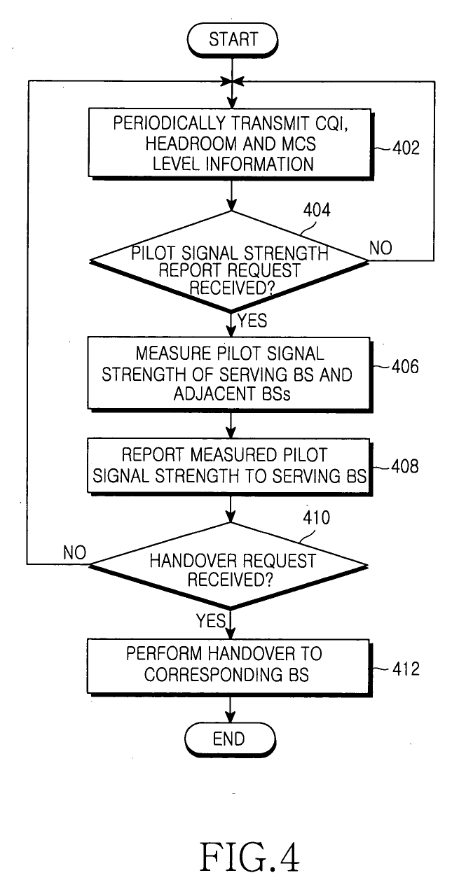

FIG. 4 is a flowchart illustrating a process of performing handover by a mobile station according to a second embodiment of the present invention.

Referring to FIG. 4, in step 402, the mobile station periodically transmits CQI, headroom, and MCS level information to a serving base station. Herein, the mobile station can select one of the MCS levels recommended by the serving base station. For example, the mobile station can select one of the MCS levels taking into account the current channel state or the amount of its transmission data. In step 404, the mobile station determines whether there is a request for a pilot signal strength report for the serving base station and adjacent base stations, received from the serving base station. Upon receipt of the pilot signal strength report request, the mobile station proceeds to step 406. However, upon failure to receive the pilot signal strength report request, the mobile station repeats step 402 and its succeeding steps.

In step 406, the mobile station, as it receives the pilot signal strength report request from the serving base station, measures pilot signal strengths of the serving base station and the adjacent base stations. In step 408, the mobile station reports the measured pilot signal strengths of the base stations to the serving base station. The mobile station determines in step 410 whether there is a request for handover to another base station different from the serving base station, received from the serving base station. Upon receipt of the handover request, the mobile station proceeds to step 412 where it performs handover to the corresponding base station determined by the serving base station. However, upon failure to receive the handover request, the mobile station repeats step 402 and its succeeding steps.

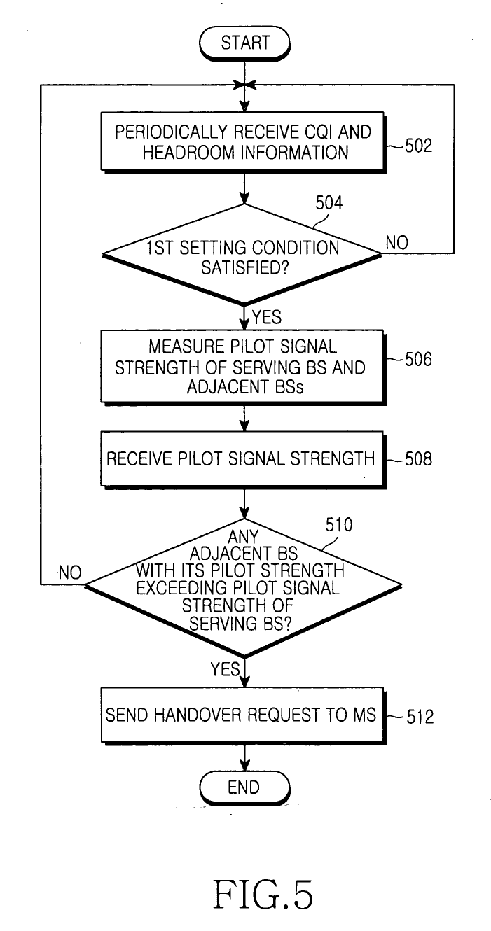

FIG. 5 is a flowchart illustrating a process of determining handover of a mobile station by a serving base station according to a first embodiment of the present invention.

Referring to FIG. 5, in step 502, the serving base station periodically receives traffic quality information including CQI and headroom information from a mobile station. In step 504, the serving base station determines whether it satisfies a preset first setting condition. Herein, the “first setting condition” refers to a process in which the serving base station determines whether the received CQI value is lower than a preset first reference value, and determines whether a value of the received headroom information is lower than a preset second reference value. That is, the serving base station considers handover of the mobile station if it satisfies the first setting condition in which the CQI value transmitted by the mobile station is lower than the first reference value and the headroom value transmitted by the mobile station is lower than the second reference value.

Therefore, in step 506, the serving base station sends a request for pilot signal strength measurement/report for the serving base station and adjacent base stations to the mobile station. In step 508, the serving base station receives pilot signal strengths of the serving base station and adjacent base stations from the mobile station. The serving base station determines in step 510 whether there is any adjacent base station whose pilot signal strength exceeds its own pilot signal strength among the pilot signal strengths reported by the mobile station. If it is determined that there is any adjacent base station whose pilot signal strength is higher than the pilot signal strength of the serving base station, the serving base station proceeds to step 512. However, if there is no such adjacent base station, the serving base station repeats step 502 and its succeeding steps. In step 512, the serving base station sends a request for handover to the corresponding base station to the mobile station.

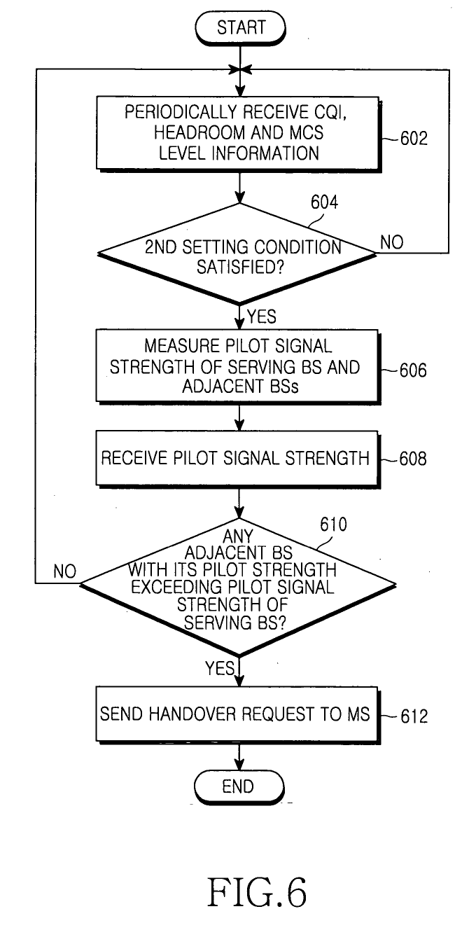

FIG. 6 is a flowchart illustrating a process of determining handover of a mobile station by a serving base station according to a second embodiment of the present invention.

Referring to FIG. 6, in step 602, the serving base station periodically receives traffic quality information including CQI, headroom and MCS level information from a mobile station. In step 604, the serving base station determines whether it satisfies a preset second setting condition. Herein, the “second setting condition” refers to a process in which the serving base station determines whether the received CQI value is lower than a preset first reference value, determines whether a value of the received headroom information is lower than a preset second reference value, and determines whether the MCS level is equal to the lowest possible MCS level. That is, the serving base station considers handover of the mobile station if it satisfies the second setting condition in which the CQI value transmitted by the mobile station is lower than the first reference value, the headroom value transmitted by the mobile station is lower than the second reference value, and the MCS level is equal to the lowest possible MCS level.

Meanwhile, the mobile station, even though its channel state to the serving base station is good, may select the lowest MCS level among the MCS levels recommended by the serving base station if the amount of its transmission data is small. On the contrary, the mobile station may select a higher MCS level when the amount of its transmission data is large. Therefore, the headroom value is used for determining traffic quality of the mobile station. That is, if the mobile station uses the lowest MCS level with the large headroom value, it indicates not the bad channel state but the small amount of its transmission data. In addition, if the mobile station uses the lowest MCS level with the small headroom value, it can determine a need for handover to keep the communication.

In step 606, the serving base station sends a request for pilot signal strength measurement/report for the serving base station and adjacent base stations to the mobile station. In step 608, the serving base station receives pilot signal strengths of the serving base station and adjacent base stations from the mobile station. The serving base station determines in step 610 whether there is any adjacent base station whose pilot signal strength exceeds its own pilot signal strength among the pilot signal strengths reported by the mobile station. If it is determined that there is any adjacent base station whose pilot signal strength is greater than the pilot signal strength of the serving base station, the serving base station proceeds to step 612. However, if there is no such adjacent base station, the serving base station repeats step 602 and its succeeding steps. In step 612, the serving base station sends a request for handover to the corresponding base station to the mobile station.

As can be understood from the foregoing description, in the mobile communication system according to the present invention, a mobile station transmits, to a serving base station, traffic quality information in an uplink and a downlink, i.e., a combination of CQI and headroom information or a combination of CQI, headroom information and MCS level information, and the serving base station can determine whether the mobile station should measure pilot signal strengths, taking the traffic quality information into account. As a result, the mobile station measures the pilot signal strengths only upon receipt of a request from the serving base station, contributing to a reduction in its calculation load caused by the pilot signal strength measurement. In addition, the mobile station takes into account the traffic quality information in both the uplink and the downlink, thereby preventing its frequent handover.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for determining handover of a mobile station by a serving base station in a mobile communication system, the method comprising the steps of:
receiving traffic quality information from the mobile station;
determining whether the traffic quality information satisfies a preset setting condition;
if the traffic quality information satisfies the setting condition, sending a request for pilot signal strength measurement for the serving base station and adjacent base stations to the mobile station;
receiving pilot signal strengths of the base stations, reported by the mobile station;
determining whether there is a corresponding base station whose pilot signal strength exceeds the pilot signal strength of the serving base station; and
determining handover of the mobile station to the corresponding base station.

2. The method of claim 1, wherein the traffic quality information includes channel quality information (CQI) determined by measuring a pilot signal from the serving base station.

3. The method of claim 1, wherein the traffic quality information includes headroom information indicating a difference between a maximum possible transmission power and a current transmission power of the mobile station.

4. The method of claim 1, wherein the traffic quality information includes modulation and coding scheme (MCS) level information selected by the mobile station.

5. The method of claim 4, wherein the MCS level information includes information on any one MCS level selected by the mobile station from a plurality of MCS levels recommended by the serving base station.

6. The method of claim 1, wherein the traffic quality information includes at least two of CQI determined by the mobile station by measuring a pilot signal from the serving base station, headroom information indicating a difference between a maximum possible transmission power and a current transmission power of the mobile station, and information on an MCS level selected by the mobile station.

7. The method of claim 1, wherein the setting condition is a condition set to determine whether a value of CQI determined by measuring a pilot signal from the serving base station is lower than a first reference value, and a headroom value indicating a difference between a maximum possible transmission power and a current transmission power of the mobile station is lower than a second reference value.

8. The method of claim 1, wherein the setting condition is a condition set to determine whether a value of CQI determined by measuring a pilot signal from the serving base station is lower than a first reference value, a headroom value indicating a difference between a maximum possible transmission power and a current transmission power of the mobile station is lower than a second reference value, and an MCS level selected by the mobile station is equal to a lowest MCS level.

9. A method for performing handover by a mobile station in a mobile communication system, the method comprising the steps of:
transmitting traffic quality information to a serving base station of the mobile station;
upon receiving a pilot signal strength measurement request from the serving base station, measuring pilot signal strengths of the serving base station and adjacent base stations, and reporting the measured pilot signal strengths to the serving base station; and
upon receiving a handover request from the serving base station, performing handover to a corresponding base station determined by the serving base station.

10. The method of claim 9, wherein the traffic quality information includes channel quality information (CQI) determined by measuring a pilot signal from the serving base station.

11. The method of claim 9, wherein the traffic quality information includes headroom information indicating a difference between a maximum possible transmission power and a current transmission power of the mobile station.

12. The method of claim 9, wherein the traffic quality information includes modulation and coding scheme (MCS) level information selected by the mobile station.

13. The method of claim 12, wherein the MCS level information includes information on any one MCS level selected by the mobile station from a plurality of MCS levels recommended by the serving base station.

14. The method of claim 9, wherein the traffic quality information includes at least two of CQI determined by the mobile station by measuring a pilot signal from the serving base station, headroom information indicating a difference between a maximum possible transmission power and a current transmission power of the mobile station, and information on an MCS level selected by the mobile station.

15. A method for performing handover between a mobile station and a serving base station in a mobile communication system, the method comprising the steps of:
transmitting, by the mobile station, traffic quality information to the serving base station;
receiving, by the serving base station, the traffic quality information from the mobile station;
determining by the serving base station whether the traffic quality information satisfies a preset setting condition;
if the setting condition is satisfied, sending a request for pilot signal strength measurement for the serving base station and adjacent base stations, to the mobile station;
measuring, by the mobile station, pilot signal strengths of the serving base station and adjacent base stations in response to the pilot signal strength measurement request from the serving base station, and reporting the measured pilot signal strengths to the serving base station;
receiving, by the serving base station, the measured pilot signal strengths of the base stations, reported by the mobile station;
determining by the serving base station whether there is a corresponding base station whose pilot signal strength exceeds the pilot signal strength of the serving base station;
if there is a corresponding base station, sending, by the serving base station, a request for handover to the corresponding base station to the mobile station; and
determining, by the mobile station, handover to the corresponding base station.

16. The method of claim 15, wherein the traffic quality information includes channel quality information (CQI) determined by measuring a pilot signal from the serving base station.

17. The method of claim 15, wherein the traffic quality information includes headroom information indicating a difference between a maximum possible transmission power and a current transmission power of the mobile station.

18. The method of claim 15, wherein the traffic quality information includes modulation and coding scheme (MCS) level information selected by the mobile station.

19. The method of claim 18, wherein the MCS level information includes information on any one MCS level selected by the mobile station from a plurality of MCS levels recommended by the serving base station.

20. The method of claim 15, wherein the traffic quality information includes at least two of CQI determined by the mobile station by measuring a pilot signal from the serving base station, headroom information indicating a difference between a maximum possible transmission power and a current transmission power of the mobile station, and information on an MCS level selected by the mobile station.

21. The method of claim 15, wherein the setting condition is a condition set to determine whether a value of CQI determined by measuring a pilot signal from the serving base station is lower than a first reference value, and a headroom value indicating a difference between a maximum possible transmission power and a current transmission power of the mobile station is lower than a second reference value.

22. The method of claim 15, wherein the setting condition is a condition set to determine whether a value of CQI determined by measuring a pilot signal from the serving base station is lower than a first reference value, a headroom value indicating a difference between a maximum possible transmission power and a current transmission power of the mobile station is lower than a second reference value, and an MCS level selected by the mobile station is equal to a lowest MCS level.

23. A system for performing handover in a mobile communication system, the system comprising:
a mobile station and a serving base station;
wherein the mobile station transmits traffic quality information to the serving base station, and upon receiving a pilot signal strength measurement request from the serving base station, measures pilot signal strengths of the serving base station and adjacent base stations and reports the measured pilot signal strengths to the serving base station, and upon receiving a handover request to a particular base station from the serving base station, performs handover to the particular base station;
wherein the serving base station receives traffic quality information from the mobile station, determines whether the traffic quality information satisfies a preset setting condition, if the setting condition is satisfied, sends a request for pilot signal strength measurement for the serving base station and adjacent base stations to the mobile station, receives pilot signal strengths of the base stations, reported by the mobile station; determines whether there is a particular base station whose pilot signal strength exceeds the pilot signal strength of the serving base station, and if there is the particular base station, sends a request for handover to the particular base station to the mobile station.

24. The system of claim 23, wherein the traffic quality information includes channel quality information (CQI) determined by measuring a pilot signal from the serving base station.

25. The system of claim 23, wherein the traffic quality information includes headroom information indicating a difference between a maximum possible transmission power and a current transmission power of the mobile station.

26. The system of claim 23, wherein the traffic quality information includes modulation and coding scheme (MCS) level information selected by the mobile station.

27. The system of claim 26, wherein the MCS level information includes information on any one MCS level selected by the mobile station from a plurality of MCS levels recommended by the serving base station.

28. The system of claim 23, wherein the mobile station transmits the traffic quality information including at least two of CQI determined by the mobile station by measuring a pilot signal from the serving base station, headroom information indicating a difference between a maximum possible transmission power and a current transmission power of the mobile station, and information on an MCS level selected by the mobile station.

29. The system of claim 23, wherein the setting condition is a condition set to determine whether a value of CQI determined by measuring a pilot signal from the serving base station is lower than a first reference value, and a headroom value indicating a difference between a maximum possible transmission power and a current transmission power of the mobile station is lower than a second reference value.

30. The system of claim 23, wherein the setting condition is a condition set to determine whether a value of CQI determined by measuring a pilot signal from the serving base station is lower than a first reference value, a headroom value indicating a difference between a maximum possible transmission power and a current transmission power of the mobile station is lower than a second reference value, and an MCS level selected by the mobile station is equal to a lowest MCS level.
